(19) United States
(12) Patent Application Publication
(10) Pub. No.: US 2009/0274994 A1
(43) Pub. Date: Nov. 5, 2009

(54) Device and Method of Securing Dental Material for Production of Dental Prosthesis

(76) Inventors: Yunoh Jung, Murray, UT (US); Daniel Yonil Jung, Murray, UT (US)

Correspondence Address: THORPE NORTH & WESTERN, LLP., P.O. Box 1219, SANDY, UT, 84091-1219, US

(21) Appl. No.: 12/431,543

(22) Filed: Apr. 28, 2009

(51) Int. Cl. A61C 5/10; A61C 19/00

(52) U.S. Cl. 433/202.1; 433/223

(57) ABSTRACT

A system and method for milling dental prostheses in a CNC milling machine includes a larger millable dental blank receivable in a primary fixture of a milling machine and capable of being machined to form one or more dental prostheses; a plurality of smaller millable dental blanks each capable of being machined to form a dental prosthesis; and lateral affixing means for affixing a lateral side of the plurality of smaller millable dental blanks in a space defined by the larger millable dental blank in the primary fixture, when the larger millable dental blank is removed.

### BACKGROUND

1. Field of the Invention

The current invention relates to securing dental material for production of dental prosthesis, such as crowns, bridges, inlays and onlays, and the like, and more particularly to a milling fixture system used in CNC milling machines used to mill dental prostheses from various dental materials and based on computer generated models of a patient's teeth.

2. Related Art

Computer Aided Design and Computer Aided Manufacturing (CAD/CAM) technology has had a big impact on the dental laboratory industry. Dental professionals can use these systems for designing a product and for controlling the manufacturing process. For example, once a dental prosthesis design has been produced with dental CAD software, CAM software controls the machines that construct the final product. The input information regarding the design of the dental prosthesis can either be created directly from the dentist's office based on a patient's intra oral image or can be created in dental laboratories based on a stone model image (or a milled or 3D printed model) which is reproduced by pouring into a dental impression or based directly on the dental impression.

So far, various CAD/CAM systems have been able to make frameworks and/or full contoured dental prosthesis for single crowns, bridges, inlays and onlays as well as custom implant abutments, and temporaries. These various CAD/CAM systems mill materials such as aluminous oxide, zirconium oxide, lithium disilicate glass ceramic, titanium, resin, feldspathic porcelain-based glass ceramics or resin-based composite blocks.

One example of a CAD/CAM made framework and/or a full contoured dental prosthesis in the dental laboratory includes making precise die models and articulated models using conventional modeling techniques which are then photographed with 3 dimensional dental optical scanners. The model is scanned in different positions and the scans are then used to calculate 3D image data. The bite record and tissue areas are also scanned. The data is processed to generate a precise 3D digital representation of the patient's mouth and/or teeth with an average marginal gap of 30 microns or under. Once all the data is calculated and the necessary 3D design of the prosthesis is done by a dental technician, it is transferred to a dental CNC milling machine.

Typical dental CNC milling machines are three dimensional mills that move a rotary cutter through an x, y, z axis envelope. A porcelain based raw material blank can be installed in a chuck or fixture within the envelope and the mill head can be moved around the blank to cut and form the blank into a desired shape. The desired shape is usually programmed into the CNC milling machine controller via a CAM based software program. Unfortunately, some milling machines can only machine a single blank at a time, resulting in the production of a single dental prosthesis. If additional dental prostheses are needed, after one blank is milled, a new blank must be installed into the fixture for machining.

To overcome the time consuming reloading procedures and problems, some CAD/CAM systems have been developed that utilize relatively large blanks of various shapes for the production of multiple prostheses. Unfortunately, due to the nature of the blank having the same material composition throughout the blank, the choice of different colors, hardness, or other material properties from a single blank is not possible. It has not been possible with current dental CAD/CAM milling machine systems to produce multiple dental prostheses, with each prosthesis having differing material properties, such as color, ceramic composition, and the like, without having to load and reload different blanks into the milling machine.

For example, the Weiland ZENO™ milling machine utilizes a large disc of a single material, such as zirconium dioxide, that fits in a round fixture in the milling machine. Similarly, Tizian CAD/CAM system utilizes a large disc or block of a single material held by a fixture in the milling machine. The Katana milling system utilizes a large block of a single material that is held by a fixture. Alternatively, the CEREC milling machine utilizes small blocks in which a single prosthesis is milled. Often, these systems are configured to use a single dental milling blank provided by the manufacturer of the milling machine.

Another attempt to solve some of these problems uses a method of securing a dental blank in a moldable material shaped to fit within a mill fixture. In this systems, the milling machine mills from a top side to eliminate the unnecessary part of the dental blank and the moldable material. Unfortunately, the machine must be temporarily stopped to turn over the dental blank and to add additional moldable material to hold the dental blank in place in order to prevent the dental blank from falling out of the fixture or becoming dislodged during subsequent milling operation. Thus, such operations are not only time consuming and inefficient because the machine must be stopped, but also add additional possibilities of manufacturing mistakes due to instabilities in the moldable material such as bubbles or cavitations that may cause weak areas that make the dental blank unstable in the milling fixture.

### SUMMARY OF THE INVENTION

It has been recognized that it would be advantageous to develop a method and device to mill multiple blanks of different characteristics, such as colors and compositions, in a single milling cycle. Additionally, it has been recognized that it would be advantageous to develop a method and device for mounting and registering dental blanks having different material characteristics in a single apparatus. In addition, it has been recognized that it would be advantageous to develop a method and device to mill not only a substructure (coping) of a dental prosthesis, framework, inlay, onlay, or implant abutment, but also a full contoured crown and bridge from different shades or materials at one single milling cycle time. Furthermore, it has been recognized that it would be advantageous to develop a method and device to alternately mill both larger and smaller millable dental blanks in the same space of a CNC milling machine.

The invention provides a system for milling dental prostheses in a CNC milling machine. A larger millable dental blank is receivable in a primary fixture of a milling machine and is capable of being machined to form one or more dental prostheses. A plurality of smaller millable dental blanks are each capable of being machined to form a dental prosthesis. The system includes a lateral affixing means for affixing a lateral side of the plurality of smaller millable dental blanks in a space defined by the larger millable dental blank in the primary fixture, when the larger millable dental blank is removed.

In accordance with a more detailed aspect of the present invention, the system includes an interchangeable jig sized and shaped as the larger millable dental blank and interchangeable with the larger millable dental blank with the primary fixture of the milling machine. The plurality of smaller millable dental blanks each have a lateral side affixed to the lateral wall of the jig.

The invention also provides a method for milling dental prostheses in a CNC milling machine includes: placing a larger millable dental blank in a primary fixture held in a milling machine; milling one or more dental prostheses in the larger millable dental blank with the milling machine; removing the larger dental blank from the primary fixture; affixing a lateral side of one or more smaller millable dental blanks in the same space occupied by the larger millable dental blank; milling one or more dental prostheses in the smaller millable dental blanks; and removing the one or more dental prostheses from the smaller millable dental blanks.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is an exploded view of a dental milling system in accordance with an embodiment of the present invention showing a jig receivable in a primary fixture of a milling machine;

FIG. 2 is a partial detailed exploded view of the dental milling system of FIG. 1;

FIG. 3 is a partial detailed view of the dental milling system of FIG. 1;

FIG. 4 is a schematic view of the dental milling system of FIG. 1;

FIG. 5a is a perspective view of a jig of the dental milling system of FIG. 1;

FIG. 5b is a top view of the jig of FIG. 5a;

FIG. 5c is a perspective view of the fig of FIG. 5a shown with smaller millable dental blanks;

FIG. 5d is a perspective view of the jig of FIG. 5a;

FIG. 5e is a cross-sectional side view of the jig of FIG. 5a taken along line 5e of FIG. 5d;

FIG. 6 is a top view of another jig of the dental milling system in accordance with another embodiment of the present invention;

FIG. 7 is a top view of another jig of the dental milling system in accordance with another embodiment of the present invention;

FIG. 8 is a partial detailed exploded view of another dental milling system in accordance with the present invention;

FIG. 9a is a perspective schematic view of another jig of the dental milling system in accordance with the present invention; FIG. 9b is a top view of the jig of FIG. 9a;

FIG. 10a is a perspective view of another jig of the dental milling system in accordance with the present invention;

FIG. 10b is a top view of the jig of FIG. 10a;

FIG. 10c is a cross-sectional side view of the jig of FIG. 10a taken along line 10c of FIG. 10b;

FIG. 11 is a partial detailed exploded view of another dental milling system in accordance with an embodiment of the present invention;

FIG. 12 is a partial detailed exploded view of another dental milling system in accordance with an embodiment of the present invention;

FIG. 13 is a top view of another dental milling system in accordance with an embodiment of the present invention;

FIG. 14a is a partial exploded view of a prior art milling system;

FIG. 14b is a partial exploded view of a dental milling system in accordance with an embodiment of the present invention;

FIG. 14c is a partial exploded view of a dental milling system in accordance with an embodiment of the present invention;

FIG. 15a is a partial exploded view of a prior art milling system;

FIG. 15b is a partial exploded view of a dental milling system in accordance with an embodiment of the present invention;

FIG. 15c is a partial exploded view of a dental milling system in accordance with an embodiment of the present invention;

FIG. 16a is a partial exploded view of a prior art milling system;

FIG. 16b is a partial exploded view of a dental milling system in accordance with an embodiment of the present invention;

FIG. 16c is a partial exploded view of a dental milling system in accordance with an embodiment of the present invention;

FIG. 17a is a partial exploded view of a prior art milling system;

FIG. 17b is a partial exploded view of a dental milling system in accordance with an embodiment of the present invention;

FIG. 17c is a partial exploded view of a dental milling system in accordance with an embodiment of the present invention;

FIG. 18 is a schematic view of a method of forming a dental prosthesis in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

The present invention provides a system and method for alternately milling both larger and smaller millable dental blanks in the same space or envelope of a CNC milling machine by affixing a lateral wall of a plurality of smaller millable dental blanks to either: 1) a jig replacing the larger millable dental blank in a primary fixture held by the CNC milling machine, 2) the primary fixture itself with the larger millable dental blank removed and the primary fixture configured to receive the plurality of smaller millable dental blanks, or 3) a secondary fixture configured to receive the plurality of smaller millable dental blanks that replaces the primary fixture in the CNC milling machine.

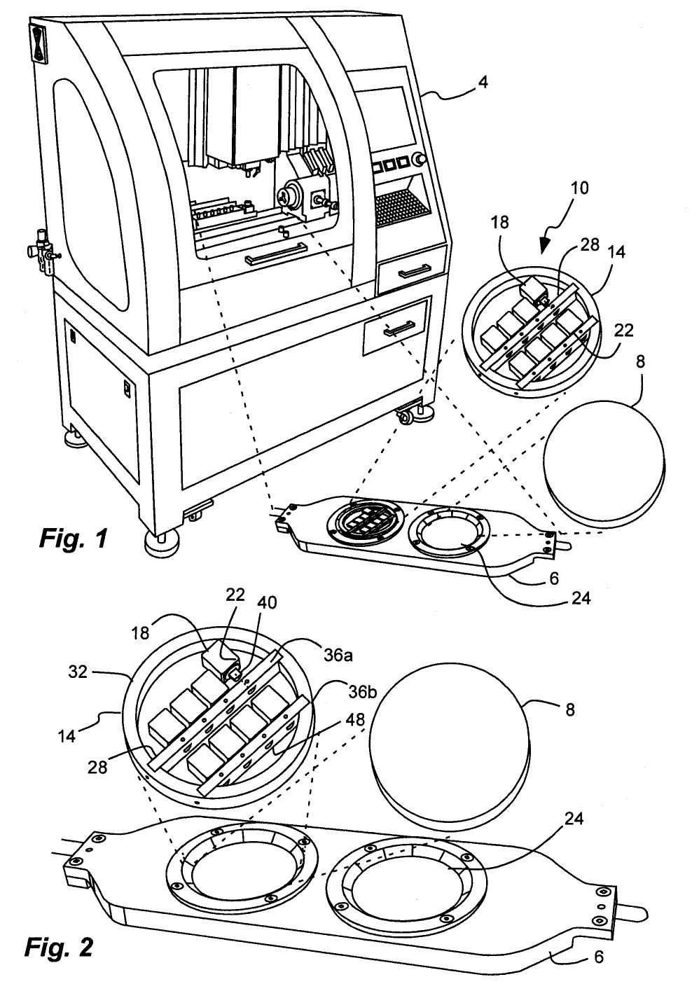

As illustrated in FIGS. 1-5e, a system, indicated generally at 10, in an example implementation in accordance with the present invention is shown for milling dental prostheses 2 in a CNC milling machine 4. The dental prostheses 2 can include crowns, bridges, copings, etc. In accordance with one aspect of the present invention, the CNC milling machine 4 can include a primary fixture 6 for receiving and holding a larger millable dental blank 8. The millable dental blank 8 can be a solid disc of constant material, such as zirconium dioxide, zirconium oxide ceramic, titanium, titanium alloy, acrylic polymer, plastic, wax, etc. The discs can be relatively large, such as 10cm in diameter, and capable of having several dental prostheses milled therein. The milling machine can include one or more chucks or the like for securely holding the primary fixture 6, and one or more cutting tools to mill the blank 8, as is known in the art. Thus, the larger millable dental blank 8 received in the primary fixture 6 of the milling machine 4 is capable of being machined to form a plurality of dental prostheses, but only of a single material with a single property or characteristic.

The system 10 can include an interchangeable jig 14 that receives and holds a plurality of smaller millable dental blanks 18 that are capable of being machined to form a plurality of dental prosthesis 2, each with a different property or characteristic, such as material or color. The smaller millable dental blanks 18 can be rectilinear blocks with a lateral side 22 affixed to, or with respect to, the jig 14. The smaller blanks 18 can be formed of various different materials with respect to one another, including feldspathic porcelain, leucite-reinforced porcelain, lithium disilicate, ceramic, composite, etc., and can have various different properties and/or characteristics with respect to one another, including color, material, etc. The jig 14 can be sized and shaped as the larger millable dental blank 8 so that it is interchangeable with the larger blank in the primary fixture 6. For example, the jig can be round to fit in a round or circular receptacle 24 of the primary fixture 6. The jig 14 has a lateral internal wall 28 against which the lateral side 22 of the smaller blanks 18 are affixed. The jig allows a plurality of smaller blanks with different properties and/or characteristics to be disposed in the space defined by the larger blanks, held by the same primary fixture as the larger blank, and milled by the same milling machine. Thus, a plurality of different prostheses, with different properties and/or characteristics, such as color and/or material, can be efficiently and conveniently milled together in the same machine and with the same fixture as the larger blanks, but without having to stop the machine and replace the larger blanks with different colors or materials. In addition, a single milling machine can be used for both larger blanks and smaller blanks.

The primary fixture 6 can be a plate and can have opposite ends to be held in opposite chucks of the milling machine. The receptacle 24 can be a round or circular opening in the plate that receives the larger blank or disc. The receptacle can have a lower annular lip forming a cavity into which the larger blanks or discs are received. A retaining ring can be secured over the opening or cavity to retain the larger blank or disc. The primary fixture can remain in the milling machine while the retaining ring and larger blank or disc are removed and replaced.

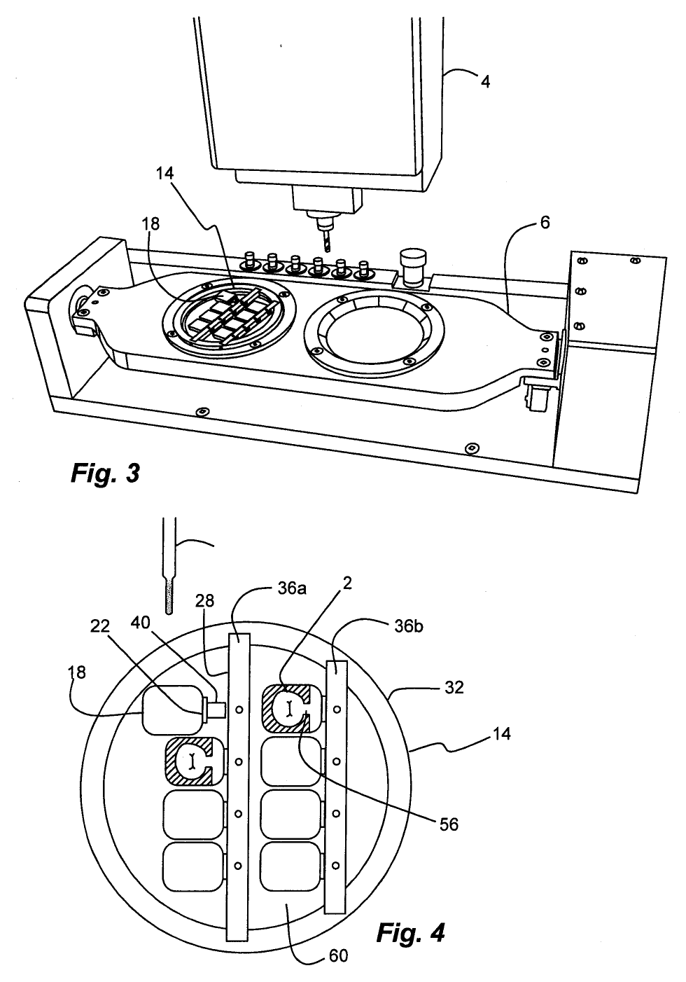

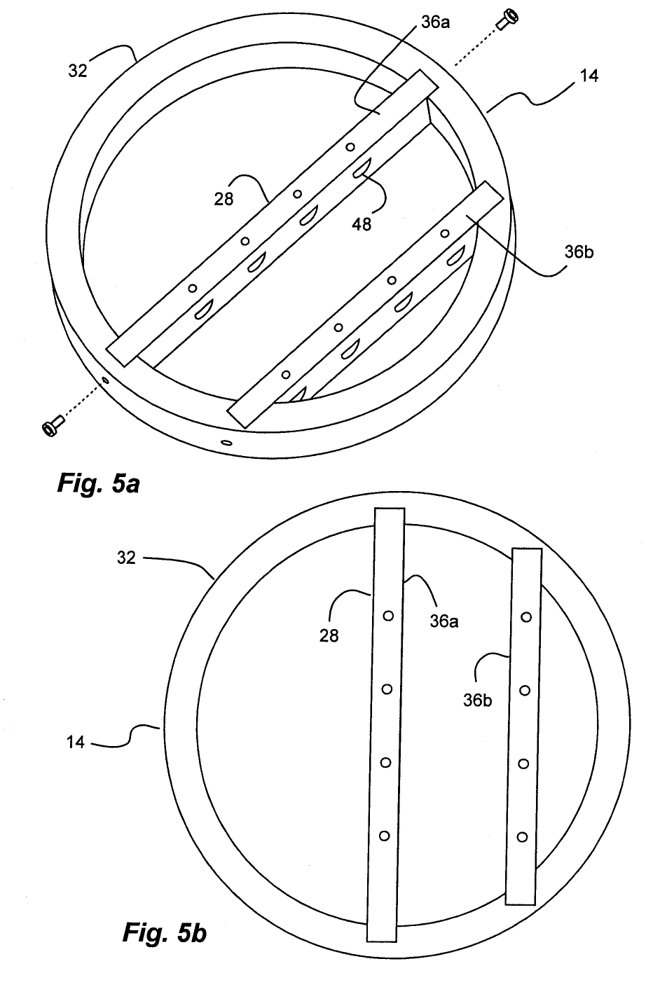

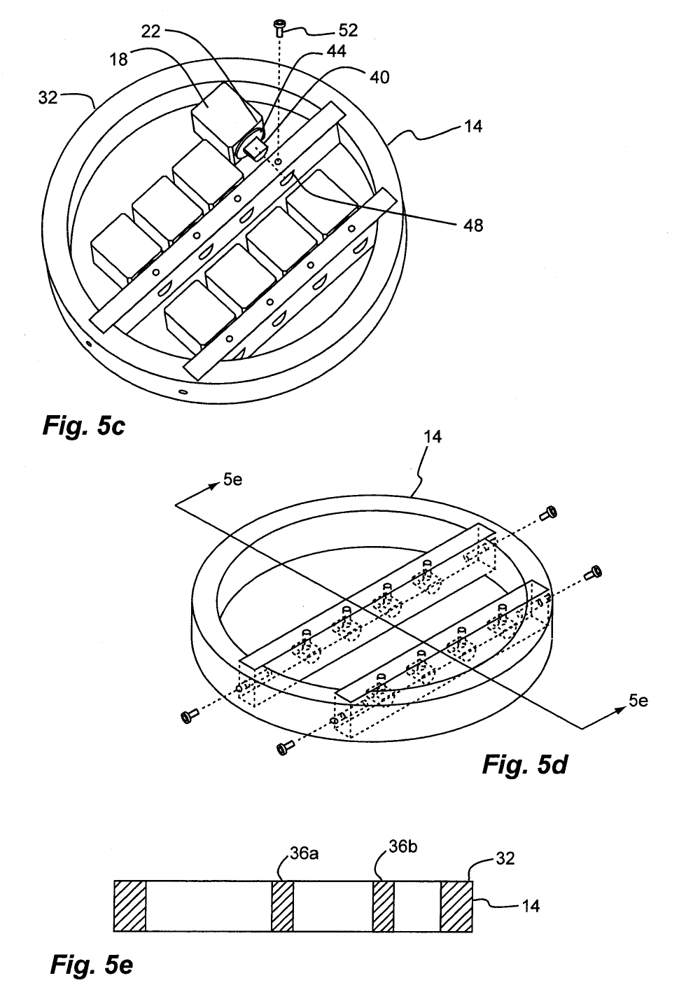

Referring to FIGS. 4-5e, the jig 14 can be a ring 32 with one or more cross members 36a and 36b spanning the ring in a spaced-apart relationship. The cross members can have or can define the lateral wall 28. The jig or ring can have an open interior space open from both sides of the ring. The smaller blanks 18 are disposed in the open interior space and have their lateral side 22 affixed to the lateral wall 28 of the cross-members 36a and 36b. The jig can be configured to carry eight smaller blanks 18 of different properties or characteristics in the same space as the single larger blank 8, or in the receptacle 24 when the larger blank 8 is removed from the receptacle or primary fixture. The ring and cross members can be metal. The cross members can have opposite ends disposed in interior notches of the ring, and secured with a fastener, such as a screw or bolt.

In accordance with one aspect of the present invention, the smaller blanks 18 can be affixed to the jig 14 with a post 40. A face 44 of the post can be directly adhered to the lateral side 22 of the smaller blank 18. The face 44 can be enlarged with respect to the post. The post can be received and secured in a notch or bore 48 of the jig or cross members. The notch or bore and the post can be shaped or keyed to align a surface of the smaller blank with respect to the jig, and thus the primary fixture and milling machine. The post can be retained in the notch or bore with a set screw 52 or the like. The set screw can thread through an orthogonal bore perpendicular to the notch or bore in the cross member to abut to the post or flat surface thereof. The posts and jig is one example of a lateral affixing means for affixing a lateral side of the plurality of smaller millable dental blanks in a space defined by the larger millable dental blank in the primary fixture, when the larger millable dental blank is removed.

With the smaller blanks 18 held by the jig 14 in the receptacle 24 of the primary fixture 6, the milling machine can mill the smaller blanks. For example, a cutting tool of the milling machine can access the smaller blanks via the open ring of the jig, and can mill the top (or bottom) and at least an upper (or lower) portion of the perimeter sides of the smaller blanks 18 to form the dental prostheses 2 in the smaller blanks. The primary fixture 6 can turn over to allow the cutting tool of the milling machine to mill the bottom (or top) and at least a lower (or upper) portion of the perimeter sides of the smaller blanks to complete the dental prostheses 2. The dental prostheses 2 can remain attached to the remainder of the smaller blanks 18 by a connector 56 extending between the prosthesis 2 and the lateral side 22 of the smaller blank 18. Thus, the prostheses 2 remain coupled to the post 40 and the jig, and thus the primary fixture 6. The lateral side 22 of smaller blanks 18 remains attached to the lateral wall 28 of the jig 14 or cross members after the prostheses are milled into the smaller blank. Thus, the prostheses remain secured during the process. Only a single lateral side 22 of each of the smaller blanks 18 is affixed, and the smaller blanks each have lateral space 60 around three sides, to allow for motion of the cutting tool of the milling machine.

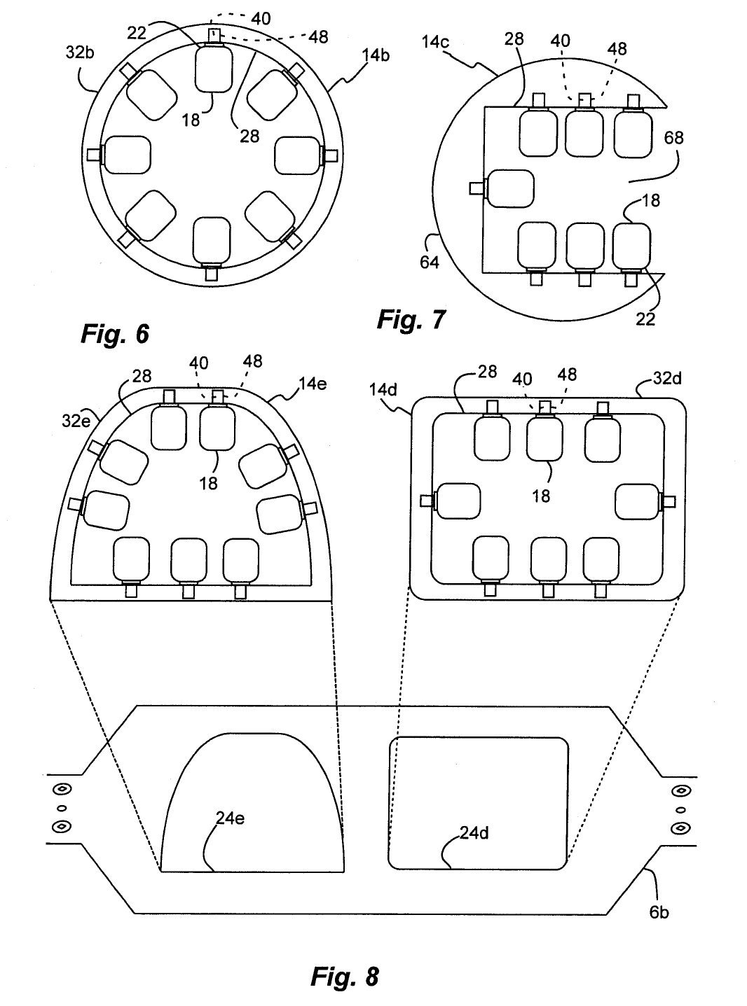

The primary fixture or receptacle thereof, and the interchangeable jig, can have different shapes and/or configurations. Referring to FIG. 6, the jig 14b can have a ring 32b with an open interior without any cross members. The lateral wall 28 can be defined by the inner perimeter of the ring 14b. The smaller blanks 18 can be affixed to the lateral wall 28 with the posts 40 extending into notches or bores 48 formed directly in the ring itself. Again, the posts and jig are an example of the lateral affixing means.

Referring to FIG. 7, the jig 14c can have a yoke or fork 64 with a substantially circular perimeter configured to mate or match the receptacle 24 of the primary fixture 6, although the perimeter need not form a complete circle or define a ring or annulus. The lateral wall 28 can be formed by an interior wall of a cavity 68 in the yoke or fork. The smaller blanks 18 can be affixed to the lateral wall 28 with the posts 40 extending into notches or bores 48 formed directly in the yoke or ring itself. Again, the posts and jig are an example of the lateral affixing means.

Referring to FIG. 8, the primary fixture 6b can have receptacles 24d and 24e with substantially rectilinear or other shapes. The jigs 14d or 14e can have a substantially rectilinear ring 32d or other shaped ring 32e that mate or match with the receptacles of the primary fixture. The lateral wall 28 can be defined by the inner perimeter of the ring 14d or 14e. The smaller blanks 18 can be affixed to the lateral wall 28 with the posts 40 extending into notches or bores 48 formed directly in the ring itself. Again, the posts and jig are an example of the lateral affixing means.

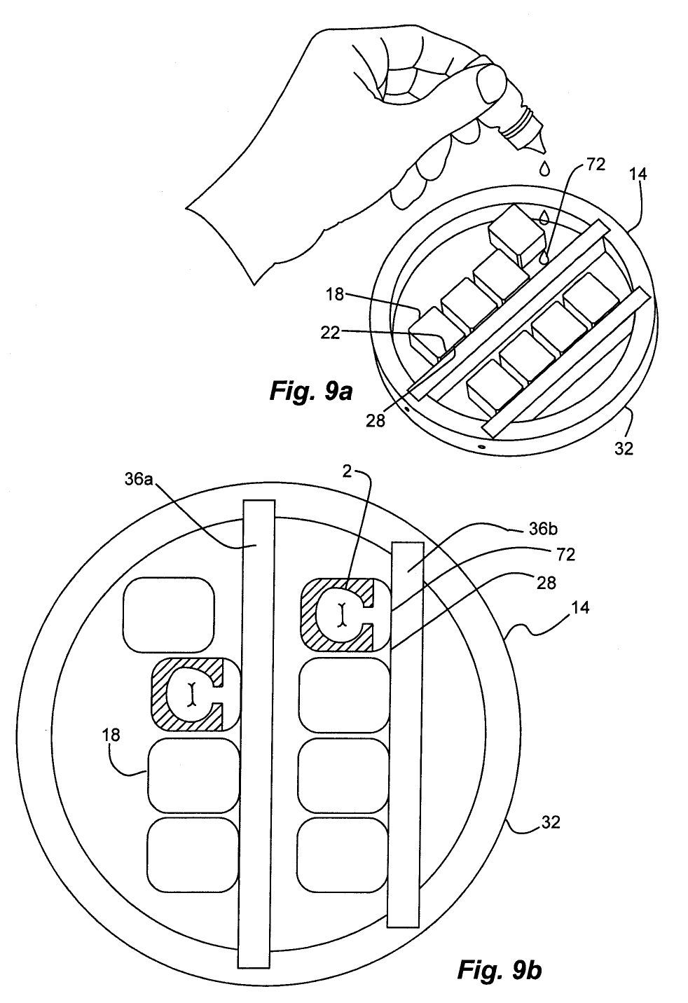

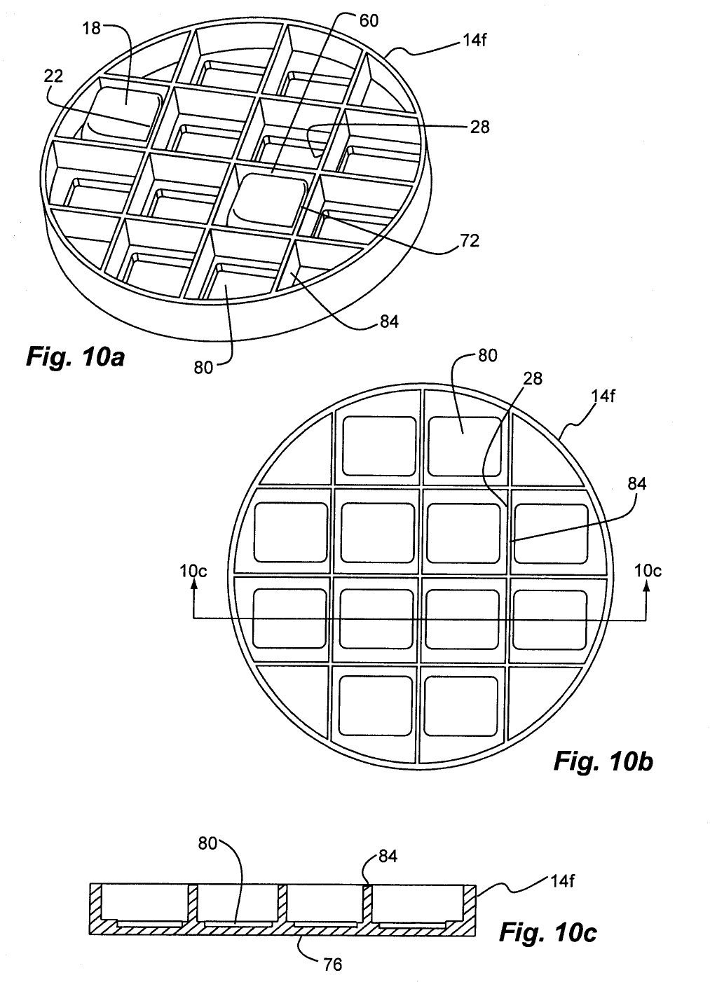

In accordance with another aspect of the present invention, the smaller blanks 18 can be directly adhered to the inner wall 28 of the jig 14 using an adhesive 72. Referring to FIGS. 9a and 9b, each of the smaller blanks 18 has its lateral side 22 adhered to the lateral wall 28 of the cross members 36a and 36b. The adhesive and jig is another example of a lateral affixing means for affixing a lateral side of the plurality of smaller millable dental blanks in a space defined by the larger millable dental blank in the primary fixture, when the larger millable dental blank is removed.

In accordance with another aspect of the present invention, the jig can include a plastic tray 14f. The tray 14f can include a sacrificial bottom wall 76 with a plurality of alignment indentations 80 to receive and align the smaller blanks 18. A lattice or plurality of intersecting walls 84 can extend across the tray and separating the smaller blanks 18. The tray 14f can be sized and shaped as the larger millable dental blank 8 so that it is interchangeable with the larger blank in the primary fixture 6. For example, the tray can be round to fit in a round or circular receptacle 24 of the primary fixture 6. The intersecting walls 84 can define the lateral wall 28 against which the lateral side 22 of the smaller blanks 18 are affixed. The smaller blanks 18 can be disposed in the alignment indentations 80 of the tray and adhered with adhesive 72 to the lateral wall 28 of the intersection walls 84 of the tray. The tray allows a plurality of smaller blanks with different properties and/or characteristics to be disposed in the space defined by the larger blank, held by the same primary fixture as the larger blank, and milled by the same milling machine.

With the smaller blanks 18 held by the tray 14f in the receptacle 24 of the primary fixture 6, the milling machine can mill the smaller blanks. For example, a cutting tool of the milling machine can access the smaller blanks via the open top of the tray, and can mill the top (or bottom) and at least an upper (or lower) portion of the perimeter sides of the smaller blanks 18 to form the dental prostheses 2 in the smaller blanks. The primary fixture 6 can turn over to allow the cutting tool of the milling machine to mill through the sacrificial bottom wall 76 of the tray to mill the bottom (or top) and at least a lower (or upper) portion of the perimeter sides of the smaller blanks to complete the dental prostheses 2. The dental prostheses 2 can remain attached to the remainder of the smaller blanks 18 by a connector 56 extending between the prosthesis 2 and the lateral side 22 of the smaller blank 18. Thus, the prostheses 2 remain coupled to the intersecting walls 84 of the tray 14f, and thus the primary fixture 6. The lateral side 22 of smaller blanks 18 remains attached to the lateral wall 28 of the tray or intersection walls after the prostheses are milled into the smaller blank. Thus, the prostheses remain secured during the process. Only a single lateral side 22 of each of the smaller blanks 18 is affixed, and the smaller blanks each have lateral space 60 around three sides, to allow for motion of the cutting tool of the milling machine. The tray can have a different size and shape to match a corresponding receptacle that can have a different size or shape as described above. In addition, the tray can have different configurations. The adhesive and tray is another example of a lateral affixing means for affixing a lateral side of the plurality of smaller millable dental blanks in a space defined by the larger millable dental blank in the primary fixture, when the larger millable dental blank is removed.

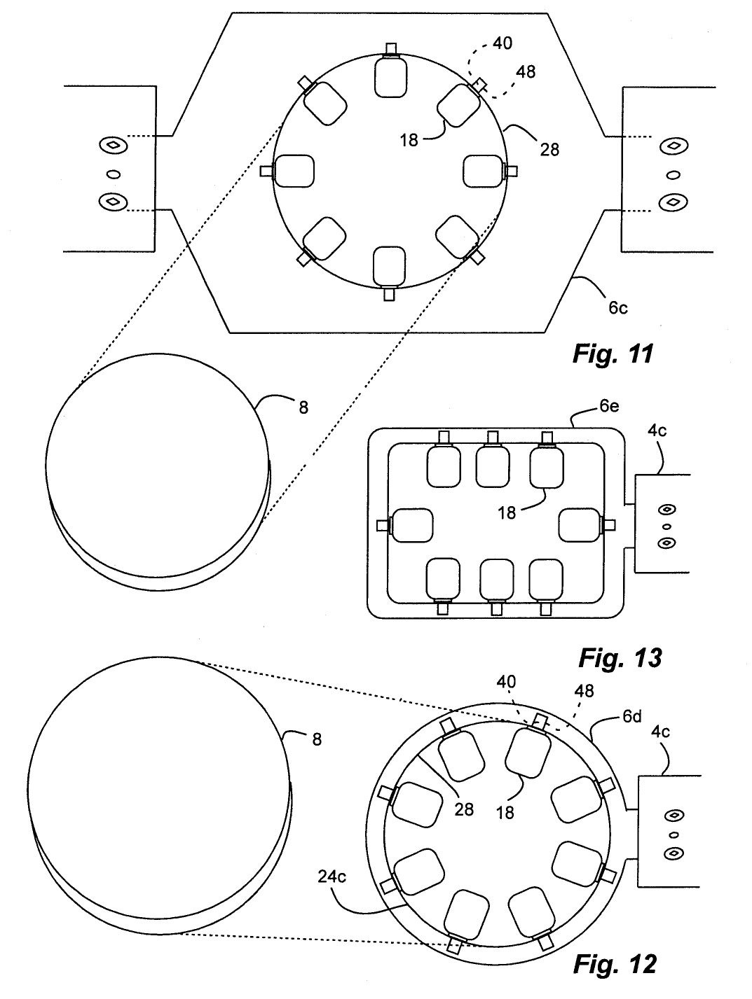

In accordance with another aspect of the present invention, the smaller blanks 18 can have their lateral wall 22 affixed to the primary fixture itself with the larger millable dental blank removed and the primary fixture configured to receive the plurality of smaller millable dental blanks. Referring to FIG. 11, the primary fixture 6c itself has been configured to receive both the smaller blanks 18 and the larger blank 8. The smaller blanks 18 have their lateral side 22 affixed to a lateral wall 28 of the primary fixture 6c itself, with the larger millable dental blank removed. A plurality of notches or bores 44 can be formed in the lateral wall 28, or within the receptacle 24, of the primary fixture. The notches or bores receive the posts 40 affixed to the smaller blanks 18 as described above. The posts and the configuration of notches in the primary fixture is another example of a lateral affixing means for affixing a lateral side of the plurality of smaller millable dental blanks in a space defined by the larger millable dental blank in the primary fixture, when the larger millable dental blank is removed.

Referring to FIG. 12, another type of milling machine 4c is shown that receives only one end of a primary fixture 6d. The primary fixture 6c again has a receptacle 24c configured to receive the larger blanks 8. The receptacle can be circular to receive round blanks or discs. As described above, the primary fixture 6c is also configured with a plurality of notches or bores 48 to receive the posts 40 of the smaller blanks 18. The posts and the configuration of notches in the primary fixture is another example of a lateral affixing means for affixing a lateral side of the plurality of smaller millable dental blanks in a space defined by the larger millable dental blank in the primary fixture, when the larger millable dental blank is removed.

Referring to FIG. 13, the milling machine 4c can receive different sized and/or shaped primary fixtures 6e configured to receive different sized and/or shaped blanks, such as rectilinear blanks (not shown). Thus, the primary fixture 6e can be substantially rectilinear. Again, the primary fixture 6d is also configured with a plurality of notches or bores 48 to receive the posts 40 of the smaller blanks 18. The posts and the configuration of notches in the primary fixture is another example of a lateral affixing means for affixing a lateral side of the plurality of smaller millable dental blanks in a space defined by the larger millable dental blank in the primary fixture, when the larger millable dental blank is removed.

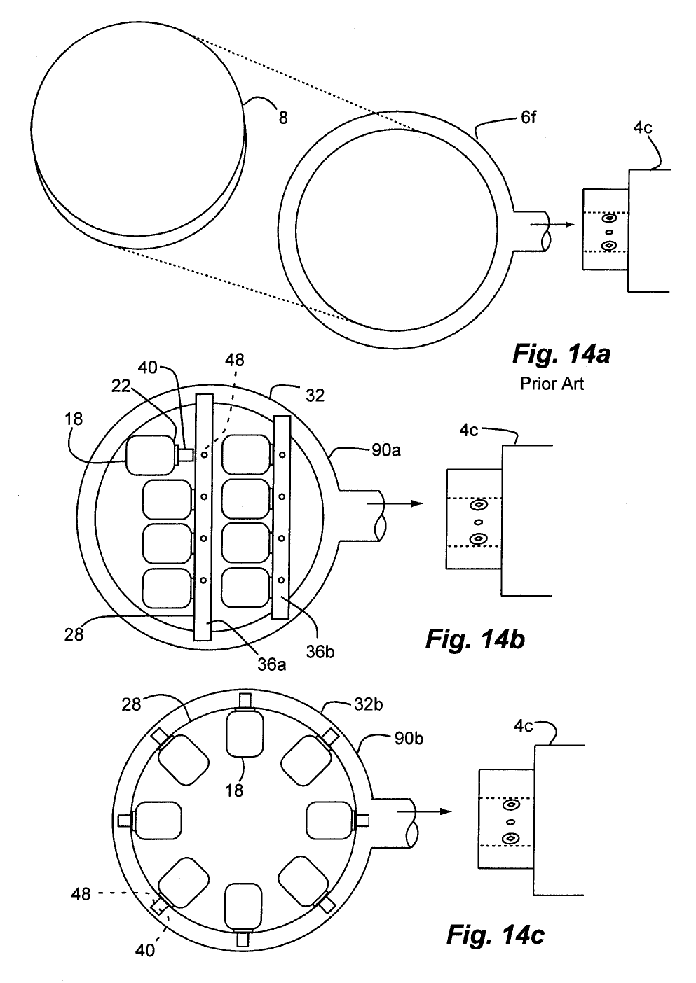

In accordance with another aspect of the present invention, the smaller blanks 18 can have their lateral wall 22 affixed to a secondary fixture configured to receive the plurality of smaller millable dental blanks that replaces the primary fixture in the CNC milling machine. The secondary fixture is capable of being held by the milling machine when the primary fixture is removed, and has a lateral wall against which the lateral side of the plurality of smaller millable dental blanks is affixed. Referring to FIG. 14a, the milling machine 4c can receive one end of a primary fixture 6e that has a receptacle to receive a larger blank 8, such as a circular blank or disc as shown. The primary fixture 6f can be removed and replaced by a secondary fixture 90a or 90b, as shown in FIGS. 14b and 14c. The secondary fixtures 90a and 90b are received by the milling machine, and can have configurations similar to the jigs described above. Referring to FIG. 14b, the secondary fixture 90a can have a ring 32 with a pair of cross members 36a and 36b as described above. The smaller blanks 18 can be affixed to posts 40 received in notches or bores 48 formed in the cross members. The posts and the configuration of the secondary fixture is another example of a lateral affixing means for affixing a lateral side of the plurality of smaller millable dental blanks in a space defined by the larger millable dental blank in the primary fixture, when the larger millable dental blank is removed. Referring to FIG. 14c the secondary fixture 90b can have a ring 32b with a plurality of notches or bores 48 as described above. The smaller blanks 18 can be affixed to posts 40 received in the notches or bores 48 as described above. The posts and the configuration of the secondary fixture is another example of a lateral affixing means for affixing a lateral side of the plurality of smaller millable dental blanks in a space defined by the larger millable dental blank in the primary fixture, when the larger millable dental blank is removed.

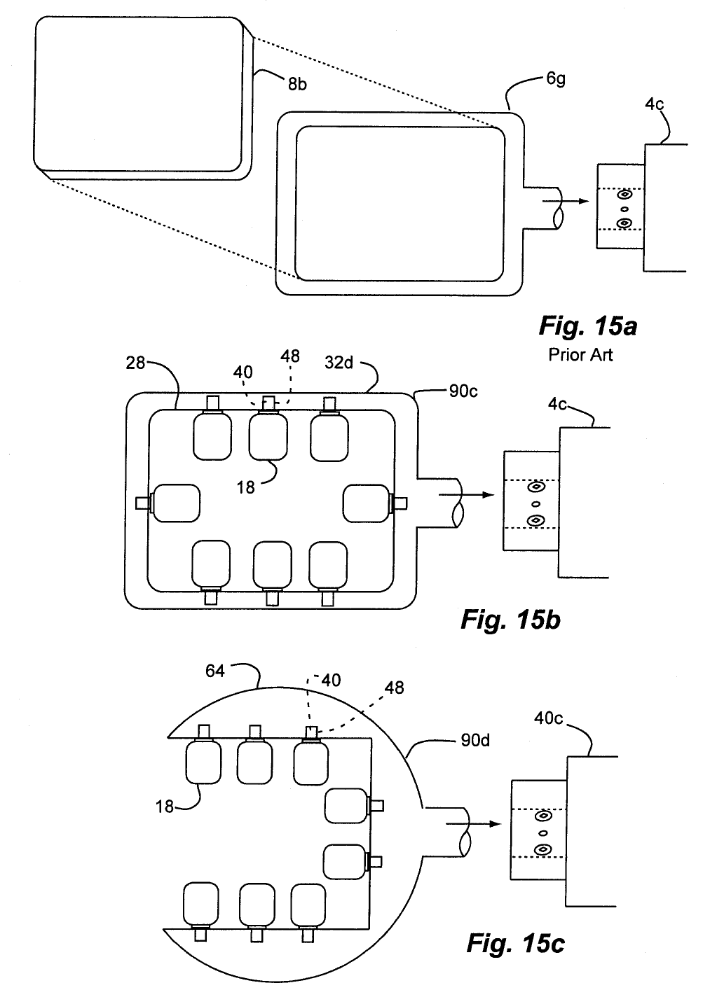

Referring to FIG. 15a, the milling machine 4c can receive one end of a primary fixture 6g that has a receptacle to receive a larger blank 8b, such as a rectilinear blank. The primary fixture 6f can be removed and replaced by a secondary fixture 90c or 90d, as shown in FIGS. 15b and 15c. The secondary fixtures 90c and 90d are received by the milling machine, and can have configurations similar to the jigs described above. Referring to FIG. 15b, the secondary fixture 90c can have a rectilinear ring 32d with a plurality of notches or bores 48 as described above. The smaller blanks 18 can be affixed to posts 40 received in the notches or bores 48 as described above. The posts and the configuration of the secondary fixture is another example of a lateral affixing means for affixing a lateral side of the plurality of smaller millable dental blanks in a space defined by the larger millable dental blank in the primary fixture, when the larger millable dental blank is removed. Referring to FIG. 15c the secondary fixture 90d can have a yoke or fork 64 with a plurality of notches or bores 48 as described above. The smaller blanks 18 can be affixed to posts 40 received in the notches or bores 48 as described above. The posts and the configuration of the secondary fixture is another example of a lateral affixing means for affixing a lateral side of the plurality of smaller millable dental blanks in a space defined by the larger millable dental blank in the primary fixture, when the larger millable dental blank is removed.

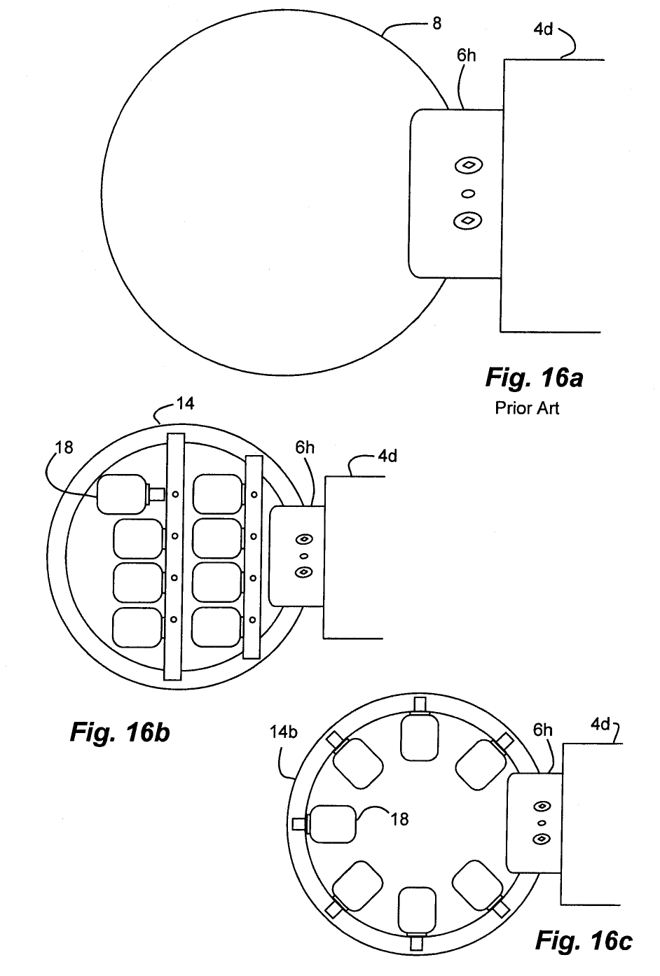

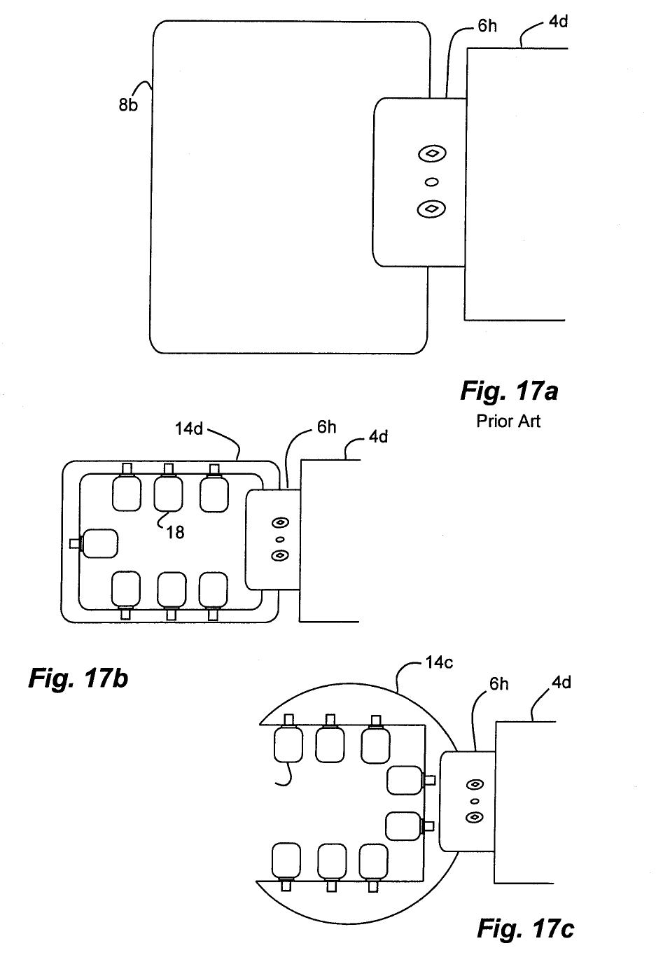

Referring to FIGS. 16a and 17a, another milling machine 4d is shown that directly receives a larger blank 8 and 8b, respectively, in a fixture or chuck 6h. Referring to FIG. 16b, 16c, 17b and 17c, the larger blank 8 or 8b can be removed from the milling machine and replaced with a jig 14, 14b, 14d or 14c, respectively, holding a plurality of smaller blanks 18 as described above. Thus, the jig is directly held by the milling machine.

In accordance with another aspect of the present invention, a method for milling dental prostheses in a CNC milling machine includes placing a larger millable dental blank 8 or 8b in a primary fixture 6-6h held in a milling machine 4-4d. One or more dental prostheses are milled in the larger millable dental blank (not shown) with the milling machine. The larger dental blank is removed from the primary fixture. A lateral side 22 of one or more smaller millable dental blanks 16 is affixed in the same space occupied by the larger millable dental blank. One or more dental prostheses 2 are milled in the smaller millable dental blanks 18. The one or more dental prostheses are removed from the smaller millable dental blanks.

The lateral side 22 of the one or more smaller millable dental blanks 18 can be affixed to a lateral wall 18 of a jig 14-14f sized and shaped as the larger millable dental blank. The jig can be placed in the primary fixture held in the milling machine. The jig can be removed from the fixture after the dental prostheses are milled.

Alternatively, the lateral side 22 of the one or more smaller millable dental blanks 18 can be affixed to a lateral wall 28 of the primary fixture 6c-6e.

Alternatively, the primary fixture 6, 6f or 6g can be removed from the milling machine. The lateral side 22 of the one or more smaller millable dental blanks 18 can be affixed to a lateral wall 28 of a secondary fixture 90a-d. The secondary fixture can be secured to the milling machine. The secondary fixture can be removed from the milling machine after milling.

In accordance with another aspect of the present invention, a method for milling dental prosthesis in a CNC milling machine includes placing a larger millable dental blank 8 or 8b in a fixture 6-6h held in a milling machine. One or more dental prostheses are milled in the larger millable dental blank with the milling machine. The larger dental blank is removed from the fixture. A lateral side 22 of one or more smaller millable dental blanks 18 is affixed to a lateral wall 28 of a jig 14-14f sized and shaped as the larger millable dental blank. The jig is placed in the fixture held in the milling machine. One or more dental prostheses 2 are milled in the smaller millable dental blanks. The jig is removed from the fixture. The smaller millable dental blanks are removed from the jig.

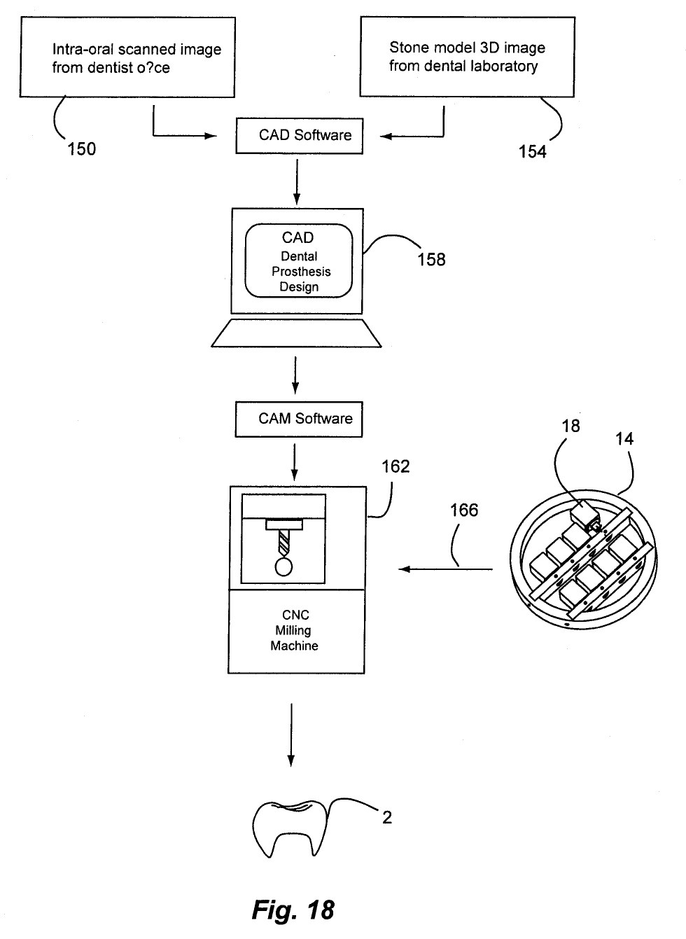

Referring to FIG. 18, the method can further include obtaining an image of the patient's teeth, such as with an intra-oral scan 150 or based on a stone model 154. CAD software is used to design 158 a dental prosthesis. CAM software is used to control a cutting tool of milling machine that mills 162 a smaller blank 18 placed 166 in the milling machine to obtain a dental prosthesis 2.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A system for milling dental prostheses in a CNC milling machine, comprising:
a) a larger millable dental blank receivable in a primary fixture of a milling machine and capable of being machined to form one or more dental prostheses;
b) a plurality of smaller millable dental blanks each capable of being machined to form a dental prosthesis; and
c) lateral affixing means for affixing a lateral side of the plurality of smaller millable dental blanks in a space defined by the larger millable dental blank in the primary fixture, when the larger millable dental blank is removed.

2. A system in accordance with claim 1, wherein the lateral affixing means comprises:
an interchangeable jig sized and shaped as the larger millable dental blank and interchangeable with the larger millable dental blank in a receptacle of the primary fixture, and having a lateral wall against which the lateral side of the plurality of smaller millable dental blanks is affixed.

3. A system in accordance with claim 2, wherein the lateral affixing means comprises:
a plurality of posts each having a face directly adhered to the lateral side of the plurality of smaller millable dental blanks; and
a plurality of notches in the jig receiving the plurality of posts.

4. A system in accordance with claim 2, wherein the larger dental blank is a disc and the receptacle is a round aperture in the primary fixture that receives the disc; and wherein the jig is sized and shaped to be received in the round aperture of the primary fixture.

5. A system in accordance with claim 4, wherein the jig further comprises:
a ring with at least one cross member defining the lateral wall.

6. A system in accordance with claim 2, wherein the jig includes a plastic tray with a sacrificial bottom wall with a plurality of alignment indentation receiving the plurality of smaller millable dental blanks.

7. A system in accordance with claim 2, wherein the jig has a rectilinear shape.

8. A system in accordance with claim 1, wherein the lateral affixing means comprises:
the plurality of smaller millable dental blanks affixed to the primary fixture itself with the larger millable dental blank removed, and having a lateral wall against which the lateral side of the plurality of smaller millable dental blanks is affixed.

9. A system in accordance with claim 8, wherein the lateral affixing means comprises:
a plurality of posts each having a face directly adhered to the lateral side of the plurality of smaller millable dental blanks; and
a plurality of notches in the primary fixture receiving the plurality of posts.

10. A system in accordance with claim 1, wherein the lateral affixing means comprises:
a secondary fixture capable of being held by the milling machine when the primary fixture is removed, and having a lateral wall against which the lateral side of the plurality of smaller millable dental blanks is affixed.

11. A system in accordance with claim 10, wherein the lateral affixing means comprises:
a plurality of posts each having a face directly adhered to the lateral side of the plurality of smaller millable dental blanks; and
a plurality of notches in the secondary fixture receiving the plurality of posts.

12. A system in accordance with claim 1, wherein the plurality of smaller millable dental blank each have lateral space around three sides.

13. A system in accordance with claim 1, wherein the plurality of smaller millable dental blanks includes smaller millable dental blanks with different colors or materials.

14. A system in accordance with claim 1, wherein only a single lateral side of each of the plurality of smaller millable dental blank is affixed.

15. A system in accordance with claim 1, wherein the lateral side of each of the plurality of smaller millable dental blanks is directly adhered to a lateral wall.

16. A system in accordance with claim 1, wherein the lateral side of the plurality of smaller millable dental blanks remains attached to the lateral wall after the smaller millable dental blank is milled.

17. A system for milling dental prostheses in a CNC milling machine, comprising:
a) a larger millable dental blank receivable by a primary fixture of a milling machine;
b) an interchangeable jig sized and shaped as the larger millable dental blank and interchangeable with the larger millable dental blank with respect to the primary fixture of the milling machine, and having a lateral wall; and
c) a plurality of smaller millable dental blanks each with a lateral side affixed to the lateral wall of the jig.

18. A system in accordance with claim 17, wherein the jig further comprises:
a ring with at least one cross member defining the lateral wall.

19. A system in accordance with claim 18, wherein each of the plurality of smaller millable dental blanks further comprises:
at least one post having a face directly adhered to the lateral side of the smaller millable dental blank and being fixable in a notch in the at least one cross member.

20. A system in accordance with claim 17, wherein the jig includes a plastic tray with a sacrificial bottom wall with a plurality of alignment indentation receiving the plurality of smaller millable dental blanks.

21. A method for milling dental prostheses in a CNC milling machine, comprising:
placing a larger millable dental blank in a primary fixture held in a milling machine;
milling one or more dental prostheses in the larger millable dental blank with the milling machine;
removing the larger dental blank from the primary fixture;
affixing a lateral side of one or more smaller millable dental blanks in the same space occupied by the larger millable dental blank;
milling one or more dental prostheses in the smaller millable dental blanks; and
removing the one or more dental prostheses from the smaller millable dental blanks.

22. A method in accordance with claim 21, further comprising:
affixing the lateral side of the one or more smaller millable dental blanks to a lateral wall of a jig sized and shaped as the larger millable dental blank;
placing the jig in the primary fixture held in the milling machine; and
removing the jig from the fixture.

23. A method in accordance with claim 21, further comprising:
affixing the lateral side of the one or more smaller millable dental blanks to a lateral wall of the primary fixture.

24. A method in accordance with claim 21, further comprising:
removing the primary fixture from the milling machine;
affixing the lateral side of the one or more smaller millable dental blanks to a lateral wall of a secondary fixture;
securing the secondary fixture to the milling machine;
removing the secondary fixture from the milling machine after milling.

25. A method for milling dental prosthesis in a CNC milling machine, comprising:
placing a larger millable dental blank in a primary fixture held in a milling machine;
milling one or more dental prostheses in the larger millable dental blank with the milling machine;
removing the larger dental blank from the primary fixture;
affixing a lateral side of one or more smaller millable dental blanks to a lateral wall of a jig sized and shaped as the larger millable dental blank;
placing the jig in the primary fixture held in the milling machine;
milling one or more dental prostheses in the smaller millable dental blanks;
removing the jig from the primary fixture; and
removing the smaller millable dental blanks from the jig.

26. A method in accordance with claim 25, wherein the larger dental blank is a disk receivable in a round aperture in the fixture; and wherein the jig is sized and shaped to be received in the round aperture of the fixture.
